(19) United States
(12) Patent Application Publication
(10) Pub. No.: US 2024/0305753 A1
(43) Pub. Date: Sep. 12, 2024

(54) ADJUSTING MODULE AND PROJECTION DEVICE

(71) Applicant: Coretronic Corporation, Hsin-Chu (TW)

(72) Inventor: Yii-Wen Chen, Hsin-Chu (TW)

(73) Assignee: Coretronic Corporation, Hsin-Chu (TW)

(21) Appl. No.: 18/595,451

(22) Filed: Mar. 5, 2024

(30) Foreign Application Priority Data
Mar. 6, 2023 (CN) 202310202700.8

(51) Int. Cl. H04N 9/31

(52) U.S. Cl. CPC H04N 9/3152; H04N 9/3164; H04N 9/3197

(57) ABSTRACT

An adjusting module, including an optical element, a first frame, a second frame, multiple elastic members, and a first adjuster. The optical element is disposed in the first frame. The first frame is disposed in the second frame. The second frame surrounds at least a portion of the first frame. The first frame includes a first wedge structure. The elastic members are connected between the first frame and the second frame. The first adjuster is disposed on the second frame and abuts against the first wedge structure of the first frame. The first adjuster is configured to move in a first direction. The first adjuster is configured to move the first frame in a second direction opposite to the second frame. The first direction is perpendicular to the second direction.

### CROSS-REFERENCE TO RELATED APPLICATION

This application claims the priority benefit of China application serial no. 202310202700.8, filed on Mar. 6, 2023. The entirety of the above-mentioned patent application is hereby incorporated by reference herein and made a part of this specification.

### BACKGROUND

### Technical Field

The disclosure relates to an adjusting element and an electronic device, and more particularly to an adjusting module and projection device.

### Description of Related Art

In a conventional illumination system of a projection device, in order to improve the efficiency of light usage, an adjusting device is configured to adjust the position of the optical element, thereby achieving the effect of adjusting the light beam. However, in a conventional adjusting device, multiple elements are required to adjust the position of the optical element. Thus, how to simplify the element amount in the adjusting device and maintain the effect provided by the adjusting device is one of the design objectives in this field.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an adjusting module, including an optical element, a first frame, a second frame, multiple elastic members, and a first adjuster. The optical element is disposed in the first frame. The first frame is disposed in the second frame. The second frame surrounds at least a portion of the first frame. The first frame includes a first wedge structure. The elastic members are connected between the first frame and the second frame. The first adjuster is disposed on the second frame and abuts against the first wedge structure of the first frame. The first adjuster is configured to move in a first direction. The first adjuster is configured to move the first frame in a second direction opposite to the second frame. The first direction is perpendicular to the second direction.

The present disclosure further provides a projection device including an illumination system, a light valve, and a projection lens. The illumination system is configured to provide an illumination beam. The illumination system includes a light source module and an adjusting module. The light source module is configured to provide a light beam. The adjusting module is disposed on a transmission path of the light beam to guide the light beam. The adjusting module includes an optical element, a first frame, a second frame, multiple elastic members, and a first adjuster. The optical element is disposed in the first frame. The first frame is disposed in the second frame. The second frame surrounds at least a portion of the first frame. The first frame includes a first wedge structure. The elastic members are connected between the first frame and the second frame. The first adjuster is disposed on the second frame and abuts against the first wedge structure of the first frame. The first adjuster is configured to move in a first direction. The first adjuster is configured to move the first frame in a second direction opposite to the second frame. The first direction is perpendicular to the second direction. The light valve is disposed on a transmission path of the illumination beam to convert the illumination beam into an image light beam. The projection lens is disposed on a transmission path of the image light beam to project the image light beam out of the projection device.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a projection device according to an embodiment of the disclosure.

FIG. 2 is a schematic diagram of an illumination system according to an embodiment of the disclosure.

FIG. 3 is a partial schematic diagram of an illumination system according to an embodiment of the disclosure.

FIG. 4 to FIG. 8 are schematic diagrams of the adjusting module in FIG. 2 at different viewing angles.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides an adjusting module and a projection device for adjusting a position of an optical element. The other objectives and advantages of the disclosure can be further understood from the descriptive features disclosed in the disclosure.

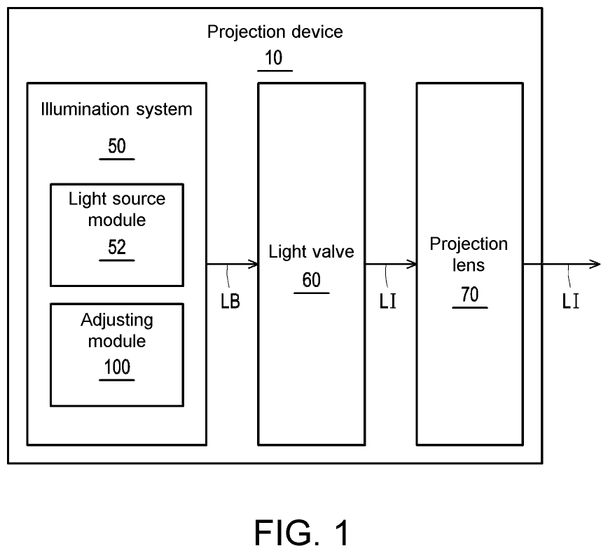

FIG. 1 is a schematic diagram of a projection device according to an embodiment of the disclosure. Referring to FIG. 1, this embodiment provides a projection device 10 including an illumination system 50, a light valve 60, and a projection lens 70. The illumination system 50 is configured to provide an illumination beam LB. The light valve 60 is disposed on the transmission path of the illumination beam LB to convert the illumination beam LB into an image light beam LI. The projection lens 70 is disposed on the transmission path of the image light beam LI and configured to project the image light beam LI out of the projection device 10 to a projection target (not shown), such as a screen or a wall.

The light valve 60 is, for example, a reflective light modulator such as a liquid crystal on silicon panel (LCoS panel) and a digital micro-mirror device (DMD). In some embodiments, the light valve 60 may also be a transmissive optical modulator, such as a transparent liquid crystal panel, an electro-optical modulator, a magneto-optical modulator, or an acousto-optic modulator (AOM). The disclosure does not limit the form and type of the light valve 60. The detailed process and implementation for the light valve 60 to convert the illumination beam LB into the image light beam LI may be obtained from general knowledge in the technical field with sufficient teaching, suggestion and implementation description, and therefore will not be repeated.

The projection lens 70 includes, for example, a combination of one or more optical lenses with diopter, such as various combinations of non-planar lenses such as biconcave lenses, biconvex lenses, concave-convex lenses, convex-concave lenses, plano-convex lenses, and plano-concave lenses. In an embodiment, the projection lens 70 may further include a flat optical lens to project the image light beam LI from the light valve 60 to the projection target in a reflective manner. The disclosure does not limit the form and type of the projection lens 70.

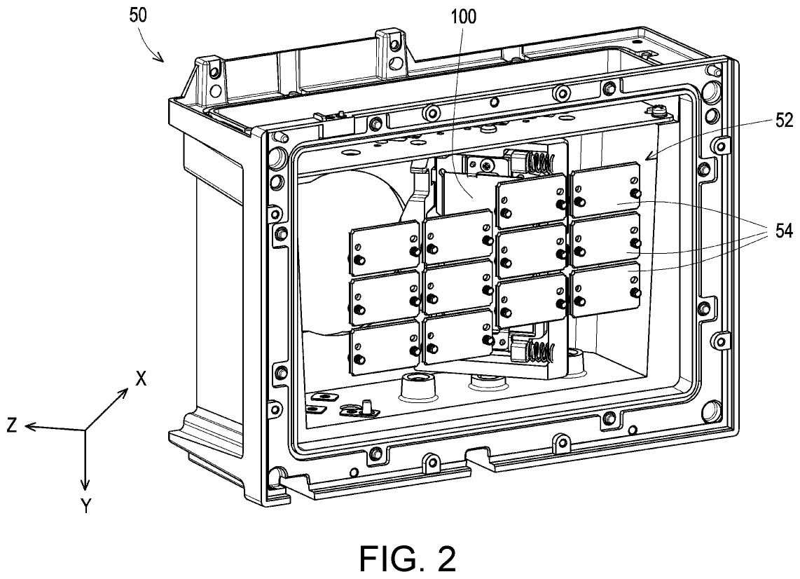

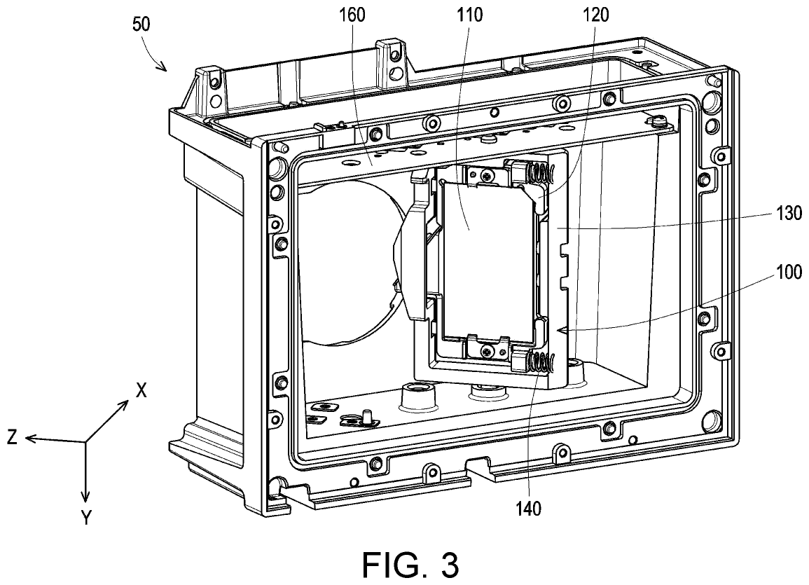

FIG. 2 is a schematic diagram of an illumination system according to an embodiment of the disclosure. FIG. 3 is a partial schematic diagram of an illumination system according to an embodiment of the disclosure. FIG. 3 shows the schematic diagram of FIG. 2 with the light source module 52 hidden. The illumination system 50 is configured to provide an illumination beam LB. The illumination system 50 includes a light source module 52 and an adjusting module 100. The light source module 52 is configured to provide light beam. For example, the light source module 52 includes multiple light-emitters 54, and the light-emitters 54 are, for example, light emitting diodes (LEDs) or Laser light source. The light-emitters 54 are, for example, arranged in an array. In an embodiment, the illumination system 50 further includes, for example, a wavelength conversion element, a uniform light element, or a filter element, etc. The illumination system 50 is configured to provide lights of different wavelengths to form an illumination beam LB having at least one color light.

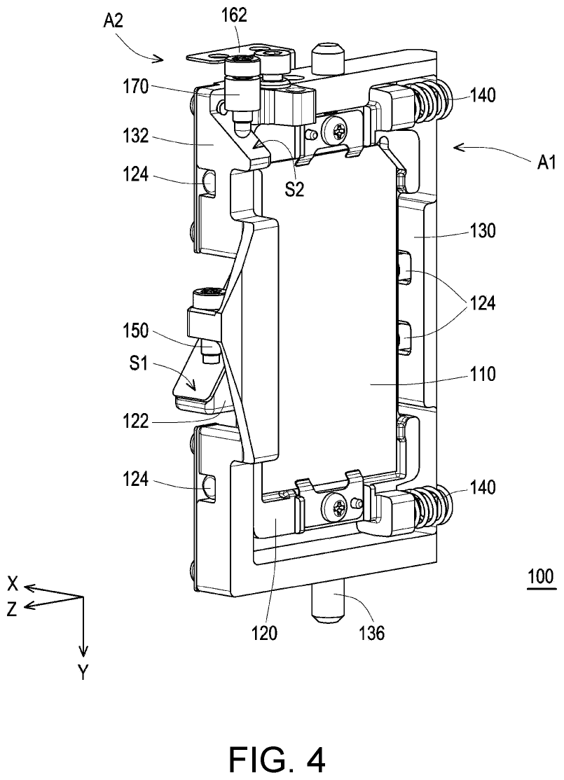

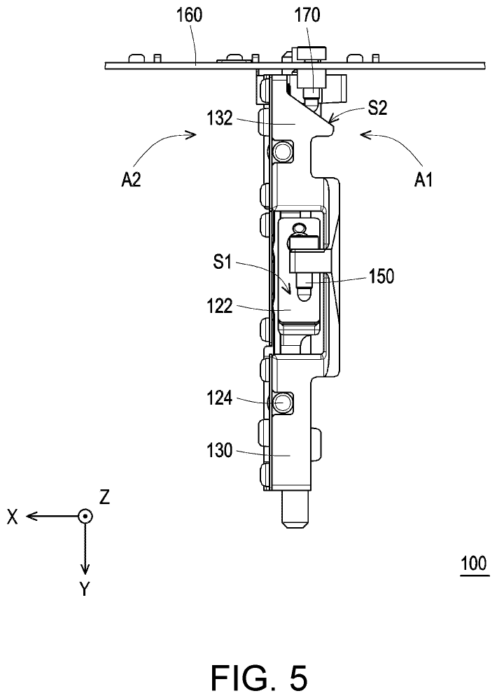

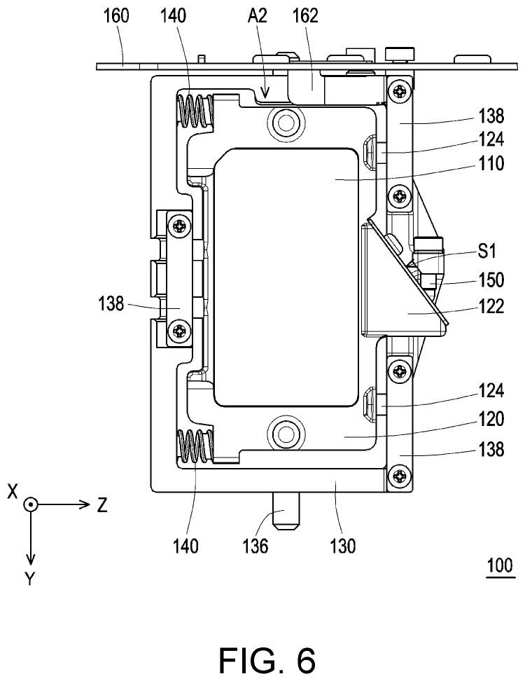

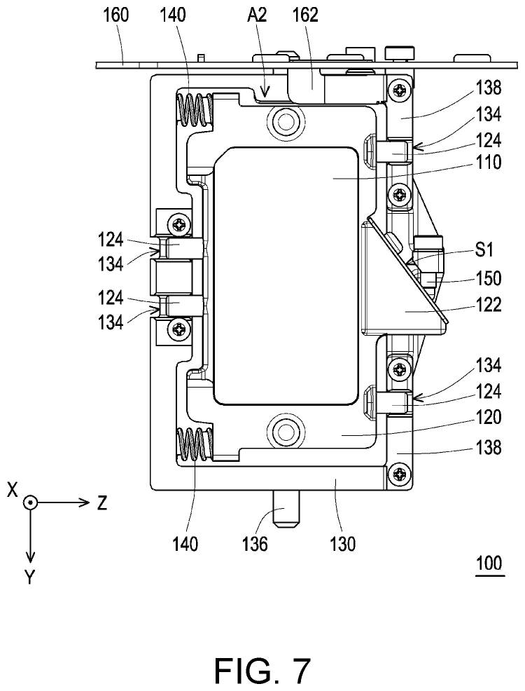

FIG. 4 to FIG. 8 are schematic diagrams of the adjusting module in FIG. 2 at different viewing angles. FIG. 7 shows the schematic diagram of FIG. 6 with the fastener 138 hidden. The adjusting module 100 is disposed on the transmission path of the light beam from the light source module 52 to guide the light beam. The adjusting module 100 includes an optical element 110, a first frame 120, a second frame 130, multiple elastic members 140, and a first adjuster 150. The optical element 110 is disposed in the first frame 120, more specifically, the optical element 110 is embedded in an inner wall of the first frame 120. The optical element 110 is, for example, a light-transmitting element made of flat glass or plastic, a light splitting element with a film layer, or a reflector, etc. The first frame 120 is disposed in the second frame 130. The second frame 130 surrounds at least a portion of the first frame 120. In other words, the first frame 120 is an inner frame, and second frame 130 is an outer frame. The first frame 120 includes a first wedge structure 122. The material of the first wedge structure 122 may include a stamping part.

The elastic members 140 are connected between the first frame 120 and the second frame 130. The elastic member 140 is, for example, a spring. The first adjuster 150 is disposed on the second frame 130 and abuts against the first wedge structure 122 of the first frame 120. The elastic members 140 provide a thrust to the first frame 120 in a positive Z direction by the second frame 130, so that the first wedge structure 122 of the first frame 120 abuts against the first adjuster 150. In this embodiment, the amount of the elastic members 140 is, for example, two.

The first adjuster 150 is configured to move in a first direction (e.g., the vertical direction), the first adjuster 150 is configured to move the first frame 120 in a second direction (e.g., the horizontal direction) opposite to the second frame 130. The first direction is perpendicular to the second direction. In this embodiment, the first direction is the direction parallel to the positive and negative Y-axes, and the second direction is the direction parallel to the positive and negative Z-axes. In this embodiment, the first adjuster 150 is, for example, a screw. The first adjuster 150 has a first external thread structure (not shown). The second frame 130 has a first internal thread structure (not shown) matching the first external thread structure. The first adjuster 150 is configured to move back and forth on the first direction by rotation. In this way, by controlling the first adjuster 150 to move in the first direction (e.g. the vertical direction), the first frame 120 may be adjusted to generate an offset in the second direction (e.g., the horizontal direction), thereby achieving the effect of adjusting the horizontal displacement of the optical element.

Specifically, in this embodiment, the first wedge structure 122 has a first inclined plane S1, and the first inclined plane S1 is inclined to the first direction and the second direction. Specifically, the normal of the first inclined plane S1 is neither parallel nor perpendicular to the first direction and the second direction. Thus, in response to the first adjuster 150 moving back and forth on the first direction, the first adjuster 150 abuts against one end of the first wedge structure 122 and slides on the first inclined plane S1, so that a moving track of the first adjuster 150 is moving back and forth on the first direction. For example, in response to the first adjuster 150 moving towards the positive Y direction, the first wedge structure 122 and other portions of the first frame 120 generate an offset towards the negative Z direction, and the elastic members 140 are compressed by the first frame 120 to achieve force balance. In response to the first adjuster 150 moving towards the negative Y direction, the first wedge structure 122 and other portions of the first frame 120 generate an offset towards the positive Z direction by the thrust of the elastic members 140.

In this embodiment, the first frame 120 further includes multiple limiting posts 124 extending towards the second frame 130 in the second direction (e.g., the positive and negative Z directions). The second frame 130 includes multiple limiting slots 134. The limiting posts 124 are disposed corresponding to the limiting slots 134. The limiting posts 124 are located in the limiting slots 134, respectively. The limiting posts 124 are configured to move in the second direction opposite to the limiting slots 134. Thus, in response to the first adjuster 150 being controlled to enable the first frame 120 to generate an offset, the matching of the limiting posts 124 and the limiting slots 134 may ensure that the first frame 120 generates an offset in the second direction (e.g., the positive and negative Z directions). In this embodiment, the second frame 130 further includes multiple fasteners 138. The fasteners 138 are configured to move the limiting posts 124 in the limiting slots 134, respectively. The first frame 120 is thereby moved in a straight line in the positive and negative Z directions, so that the limiting posts 124 do not offset in other directions (e.g., the positive and negative X directions). The fastener 138 is, for example, a stamping part.

On the other hand, in this embodiment, the adjusting module 100 further includes a base 160. The second frame 130 includes a rotation axis 136 extending in the first direction. The rotation axis 136 is connected to the base 160, so that the second frame 130 is pivotally connected to the base 160 rotatably through the rotation axis 136. The second frame 130 is configured to rotate around the rotation axis 136. The first frame 120 and the second frame 130 respectively form a movable inner frame and outer frame. In addition to the horizontal offset of the optical element 110 through the first frame 120, the adjusting module 100 of this embodiment may further change the rotation angle of the optical element 110 through the second frame 130, so as to provide adjustments in different dimensions, thereby improving the optical effect.

Specifically, the adjusting module 100 further includes a second adjuster 170 disposed on the base 160. Similar to the matching relationship between the first wedge structure 122 and the first adjuster 150, the second frame 130 includes a second wedge structure 132, and the second adjuster 170 abuts against the second wedge structure 132. The material of the second wedge structure 132 may include a stamping part. The second adjuster 170 is configured to move in a first direction, and the second adjuster 170 is configured to rotate the second frame 130 around the rotation axis 136. In this embodiment, similar to the first adjuster 150, the second adjuster 170 is, for example, a screw. The second adjuster 170 has a second external thread structure (not shown). The base 160 has a second internal thread structure (not shown) matching the second external thread structure, and the second adjuster 170 is configured to move back and forth on the first direction by rotation.

More specifically, the second wedge structure 132 has a second inclined plane S2, and the second inclined plane S2 is inclined to the first direction and a third direction. In this embodiment, the third direction is the direction parallel to the positive and negative X axes, and the third direction is perpendicular to the first direction and the second direction. Specifically, the normal of the second inclined plane S2 is neither parallel nor perpendicular to the first direction and the third direction. In addition, in this embodiment, the base 160 includes a metal dome 162 abutting against the second frame 130. The second frame 130 has a first side A1 and a second side A2 opposing each other. The second adjuster 170 abuts against the first side A1, and the metal dome 162 abuts against the second side A2. Thus, in response to the second adjuster 170 moving back and forth on the first direction, the second adjuster 170 abuts against one end of the second wedge structure 132 and slides on the second inclined plane S2, so that a moving track of the second adjuster 170 is moving back and forth on the first direction. In this embodiment, the second wedge structure 132 is disposed on the first side A1 of the second frame 130. The first side A1 is a lateral surface parallel to a YZ plane. The first wedge structure 122 is disposed on a left lateral surface or a right lateral surface of the first frame 120. The left lateral surface and the right lateral surface are parallel to a XY plane. The normal of the first inclined plane S1 and the normal of the second inclined plane S2 show a skewed configuration.

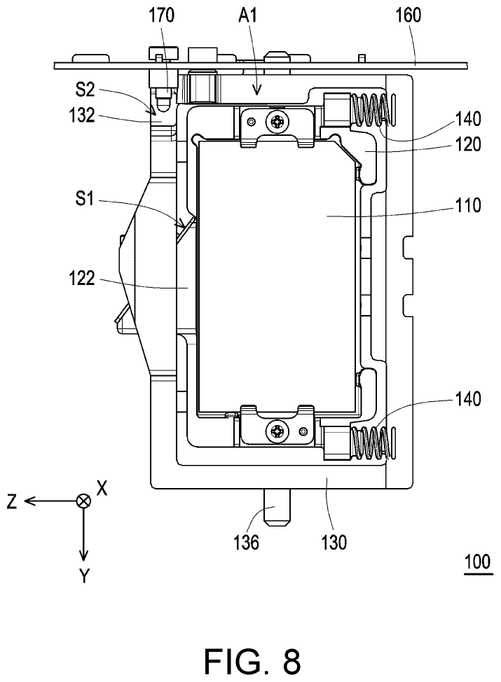

In detail, taking the schematic diagram in FIG. 8 as an example, in response to the second adjuster 170 moving towards the positive Y direction, the second wedge structure 132 and other portions of the second frame 130 rotate in a clockwise direction with the rotation axis 136 as a center, and the metal dome 162 is compressed by the second frame 130 to achieve force balance. In response to the second adjuster 170 moving towards the negative Y direction, the second wedge structure 132 and other portions of the second frame 130 rotate in a counter-clockwise direction with the rotation axis 136 as the center by the thrust of the metal dome 162. In this way, the embodiment may further generate an angle offset by controlling the second adjuster 170 to adjust the second frame 130 to rotate around the rotation axis 136. In response to the rotation of the second frame 130, the first frame 120 and the optical element 110 also rotate together, thereby achieving the effect of rotating and adjusting the angle of the optical element 110. That is, the adjusting module 100 of this embodiment has the design of adjusting the horizontal displacement and the rotation angle of the optical element 110 at the same time. In addition, in response to adjusting the horizontal displacement and/or rotation angle of the optical element 110, the first adjuster 150 and the second adjuster 170 both move in the first direction. In this way, the effect of convenient operation may be achieved.

To sum up, in the adjusting module and the projection device of the disclosure, the first frame and the second frame respectively form a movable inner frame and outer frame. The first wedge structure of the first frame abuts against the first adjuster. By controlling the first adjuster to move in a vertical direction, the first frame generates an offset of a horizontal direction. In this way, the effect of adjusting the horizontal displacement of the optical element may be achieved.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. An adjusting module, comprising an optical element, a first frame, a second frame, a plurality of elastic members, and a first adjuster, wherein:
the optical element is disposed in the first frame;
the first frame is disposed in the second frame, the second frame surrounds at least a portion of the first frame, the first frame comprises a first wedge structure;
the plurality of elastic members are connected between the first frame and the second frame; and
the first adjuster is disposed on the second frame and abuts against the first wedge structure of the first frame, wherein the first adjuster is configured to move in a first direction, the first adjuster is configured to move the first frame in a second direction opposite to the second frame, and the first direction is perpendicular to the second direction.

2. The adjusting module according to claim 1, wherein the first frame further comprises a plurality of limiting posts, the plurality of limiting posts extend towards the second frame in the second direction, the second frame comprises a plurality of limiting slots, the plurality of limiting posts are located in the plurality of limiting slots, and the plurality of limiting posts are configured to move in the second direction opposite to the plurality of limiting slots.

3. The adjusting module according to claim 1, wherein the first wedge structure has a first inclined plane, and the first inclined plane is inclined to the first direction and the second direction.

4. The adjusting module according to claim 1, wherein the first adjuster has a first external thread structure, the second frame has a first internal thread structure matching the first external thread structure, and the first adjuster is configured to move back and forth on the first direction by rotation.

5. The adjusting module according to claim 1, wherein the adjusting module further comprises a base, the second frame comprises a rotation axis extending in the first direction, the rotation axis is connected to the base, and the second frame is configured to rotate around the rotation axis.

6. The adjusting module according to claim 5, wherein the adjusting module further comprises a second adjuster disposed on the base, the second frame comprises a second wedge structure, the second adjuster abuts against the second wedge structure, the second adjuster is configured to move in the first direction, and the second adjuster is configured to rotate the second frame around the rotation axis.

7. The adjusting module according to claim 6, wherein the second wedge structure has a second inclined plane, the second inclined plane is inclined to the first direction and a third direction, and the third direction is perpendicular to the first direction and the second direction.

8. The adjusting module according to claim 7, wherein a normal of a first inclined plane and a normal of the second inclined plane show a skewed configuration.

9. The adjusting module according to claim 6, wherein the base comprises a metal dome abutting against the second frame, the second frame has a first side and a second side opposing each other, the second adjuster abuts against the first side, and the metal dome abuts against the second side.

10. The adjusting module according to claim 6, wherein the second adjuster has a second external thread structure, the base has a second internal thread structure matching the second external thread structure, and the second adjuster is configured to move back and forth on the first direction by rotation.

11. A projection device, comprising an illumination system, a light valve, and a projection lens, wherein:
the illumination system is configured to provide an illumination beam, and the illumination system comprises a light source module and an adjusting module, wherein:
the light source module is configured to provide a light beam; and
the adjusting module is disposed on a transmission path of the light beam to guide the light beam, and the adjusting module comprises an optical element, a first frame, a second frame, a plurality of elastic members, and a first adjuster, wherein:
the optical element is disposed in the first frame;
the first frame is disposed in the second frame, the second frame surrounds at least a portion of the first frame, the first frame comprises a first wedge structure;
the plurality of elastic members are connected between the first frame and the second frame; and
the first adjuster is disposed on the second frame and abuts against the first wedge structure of the first frame, wherein the first adjuster is configured to move in a first direction, the first adjuster is configured to move the first frame in a second direction opposite to the second frame, and the first direction is perpendicular to the second direction;
the light valve is disposed on a transmission path of the illumination beam to convert the illumination beam into an image light beam; and
the projection lens is disposed on a transmission path of the image light beam to project the image light beam out of the projection device.

12. The projection device according to claim 11, wherein the first frame further comprises a plurality of limiting posts, the plurality of limiting posts extend towards the second frame in the second direction, the second frame comprises a plurality of limiting slots, the plurality of limiting posts are located in the plurality of limiting slots, and the plurality of limiting posts are configured to move in the second direction opposite to the plurality of limiting slots.

13. The projection device according to claim 11, wherein the first wedge structure has a first inclined plane, and the first inclined plane is inclined to the first direction and the second direction.

14. The projection device according to claim 11, wherein the first adjuster has a first external thread structure, the second frame has a first internal thread structure matching the first external thread structure, and the first adjuster is configured to move back and forth on the first direction by rotation.

15. The projection device according to claim 11, wherein the adjusting module further comprises a base, the second frame comprises a rotation axis extending in the first direction, the rotation axis is connected to the base, and the second frame is configured to rotate around the rotation axis.

16. The projection device according to claim 15, wherein the adjusting module further comprises a second adjuster disposed on the base, the second frame comprises a second wedge structure, the second adjuster abuts against the second wedge structure, the second adjuster is configured to move in the first direction, and the second adjuster is configured to rotate the second frame around the rotation axis.

17. The projection device according to claim 16, wherein the second wedge structure has a second inclined plane, the second inclined plane is inclined to the first direction and a third direction, and the third direction is perpendicular to the first direction and the second direction.

18. The projection device according to claim 17, wherein a normal of a first inclined plane and a normal of the second inclined plane show a skewed configuration.

19. The projection device according to claim 18, wherein the base comprises a metal dome abutting against the second frame, the second frame has a first side and a second side opposing each other, the second adjuster abuts against the first side, and the metal dome abuts against the second side.

20. The projection device according to claim 16, wherein the second adjuster has a second external thread structure, the base has a second internal thread structure matching the second external thread structure, and the second adjuster is configured to move back and forth on the first direction by rotation.
